(19) United States
(12) Patent Application Publication
(10) Pub. No.: US 2024/0261867 A1
(43) Pub. Date: Aug. 8, 2024

(54) MACHINE TOOL FOR MACHINING A MICROMECHANICAL COMPONENT, AND MACHINING METHOD IMPLEMENTED BY SAID MACHINE TOOL

(71) Applicant: PETITPIERRE SA, Cortaillod (CH)

(72) Inventors: Philippe JACOT, Bevaix (CH); Ivan CALDERON, Bôle (CH)

(21) Appl. No.: 18/562,764

(22) PCT Filed: May 31, 2022
(86) PCT No.: PCT/EP2022/064698

§ 371 Date: Nov. 20, 2023

(30) Foreign Application Priority Data
May 31, 2021 (EP) 21176764.5

(51) Int. Cl. B23B 25/06; B23B 1/00

(52) U.S. Cl. CPC B23B 25/06; B23B 1/00

(57) ABSTRACT

A machine tool for machining a piece has an axis of rotation A, and includes a no-force precision machining unit to machine the piece, a first spindle, a first clamping device clamping the piece and mounting it on the first spindle, and a machine parameters guidance system. The guidance system guides a controller for the machining unit to control a first machining phase of the piece on the first spindle programmed to obtain a blank mounted on the first spindle, with target dimensions are 0.5% to 20% greater than the final dimensions, then to modify the machining parameters to control, starting from the blank on the first spindle, a second machining phase to remove a quantity of material to obtain the finished piece, with the final dimensions and a roughness of less than 40 nm. A method for machining a piece using such a machine tool is also described.

### TECHNICAL FIELD

The present invention relates to a machine tool for machining a piece, in particular a micromechanical piece, having at least one surface of revolution with axis of rotation A, said machine tool comprising no-force precision machining means arranged to machine the piece, a lathe comprising at least one first spindle having an axis of rotation B extending along the Z axis into an XYZ coordinate system, said first spindle being movable in translation along the Z axis and in rotation around its axis of rotation B, a first clamping device arranged to clamp the piece to be machined and to mount it on the first spindle, a first optical measurement system for the piece integrated into the first spindle and arranged to at least measure the actual dimensions of the piece when it is mounted on the first spindle using the first clamping device, and a guidance system arranged to manage machining parameters, the guidance system comprising:
recording means for predetermined final dimensions of the piece to be achieved following machining with a predefined tolerance,
control means for the first optical measurement system in order to measure and record actual dimensions of the piece mounted on the first spindle,
comparison means for comparing the actual measured dimensions of the piece with at least the predetermined final dimensions,
correction means for adapting the machining parameters in accordance with the comparison of the actual measured dimensions of the piece with at least the predetermined final dimensions,
control means for the no-force precision machining means in order to machine the piece in accordance with the machining parameters.

The present invention also relates to a method for machining a piece, in particular a micromechanical piece, implemented by said machine tool.

### PRIOR ART

Such pieces, in particular micromechanical pieces, can be, for example, precision axes which can have very small dimensions like watchmaking pivots such as balance axes, for example, involving very small diameters, up to 60 microns or less.

Traditionally, turning machines using no-force or effortless machining such as femtosecond laser turning, electrical discharge turning or turning by electrochemical process are guided in the standard manner, that is to say that the pieces are machined and then extracted from the machining area and measured.

The results of the measurements serve to correct the machining parameters of the machine in order to obtain the dimensions of the pieces within the desired tolerances.

For this reason, if this procedure is adopted, a machining defect is only detected after the event a relatively long time after the piece has been completely machined.

The state of the machine tool will then have every chance of having evolved (in terms of thermal expansion or other factors responsible for drift), making the correction of the machine tool on the basis of the measurement of the piece relatively inaccurate or even erroneous.

The publication by Warhanek and al. “Accurate Micro-Tool Manufacturing by Iterative Pulsed-Laser Ablation”, Lasers in Manufacturing and Materials Processing, Vol. 4, No. 4, 23 Oct. 2017 (2017-10-23), pages 193-204, XP055857312, ISSN: 2196-7229, DOI: 10.1 007/s4051 6-01 7-0046-y: Internet extract: URL: http://link.springer.com/content/pdf/1 0.1 007/s4051 6-01 7-0046-y.pdf describes a method and a prototype machine for manufacturing cutting tools having a diameter between 0.5 mm and 1.5 mm, these tools being produced from specific materials such as cBN or WC. The machine uses a nanolaser. FIG. 1 shows the strong non-linearity as regards deviations with respect to the diameter sought for two different lasers: nanosecond and picosecond. This shows that it is not possible for the person skilled in the art to deduce any related correlation between two pulse lengths of different lasers and their performance or effectiveness in terms of material removal. The results between the nanolaser and the pico laser cannot be transposed.

Furthermore, this document proposes an iterative correction method, based on modeled or iterative measures starting from an algorithm, and on the use of a compensation card with continuous regulation of the laser which is constantly repositioning itself. Such a process is complex to implement in an industrial environment. Furthermore, it makes it possible to obtain profile and diameter tolerances of the order of 5 μm, roughness values Ra of the order of 55 nm, which is not sufficient in the watchmaking field.

Document EP 1 226 899 describes a machining method and a machine tool which in particular comprises a measuring and aligning station, a first processing station and a second processing station, the measuring and aligning station being located in a location different from that of the first and second processing stations. The disadvantage of this is that the piece has to be transferred between the measuring and aligning station and the first or second processing station. This piece transferring operation results in the loss of numerous microns of precision.

On the other hand, traditionally, precision axes machined by turning (including turning by effortless machining such as femtosecond laser turning, electrical discharge turning or turning by electrochemical process) starting from workpieces or blanks use traditional turning spindles and counter-spindles equipped with collet clamps, chuck clamps, or other existing types of clamping. These types of correction clamps do not make it possible to guarantee a high level of concentricity of the correction machining. Tailstocks can be used to improve the machining, but the latter cannot in principle be used in the case of very small pieces. It is then necessary to machine the entire piece in a single clamp, sacrificing the material which is in the clamp, especially when the two ends of a piece need to be machined. This procedure makes it possible to ensure concentricity between the different diameters of the piece. However, in principle, the final cut of the piece requires the use of a counter-spindle which will support the piece during this operation. This machining procedure does not make it possible to divide the machining of the piece into spindle and counter-spindle, which diminishes the productivity of the machine by a factor which can be up to 2.

The present invention aims to remedy these drawbacks by proposing a machine tool and a method for machining pieces, in particular micromechanical pieces, such as watchmaking pivot axes, making it possible to obtain machined pieces having extreme qualities of concentricity, coaxiality, precision, roughness and tolerance.

### DISCLOSURE OF THE INVENTION

To this end, the invention relates to a machine tool for machining a piece, in particular a micromechanical piece, having at least one surface of revolution with axis of rotation A, said machine tool comprising no-force precision machining means arranged to machine the piece, a lathe comprising at least one first spindle having an axis of rotation B extending along the Z axis into an XYZ coordinate system, said first spindle being movable in translation along the Z axis and in rotation around its axis of rotation B, a first clamping device arranged to clamp the piece to be machined and to mount it on the first spindle, a first optical measurement system for the piece integrated into the first spindle and arranged to at least measure the actual dimensions of the piece when it is mounted on the first spindle using the first clamping device, and a guidance system arranged to manage machining parameters, said guidance system comprising:
recording means for predetermined final dimensions of the piece to be achieved following machining with a predefined tolerance,
control means for the first optical measurement system in order to measure and record actual dimensions of the piece mounted on the first spindle,
comparison means for comparing the actual measured dimensions of the piece with at least the predetermined final dimensions,
correction means for adapting the machining parameters in accordance with the comparison of the actual measured dimensions of the piece with at least the predetermined final dimensions,
control means for the no-force precision machining means in order to machine the piece in accordance with the machining parameters.

According to the invention, said guidance system is arranged to guide said control means for the first optical measurement system, said comparison means, said control means for the machining means, and possibly said correction means, in order to control a first machining phase of the piece mounted on the first spindle that is programmed to obtain a blank mounted on the first spindle, of which the target dimensions are 0.5% to 20% greater than the predetermined final dimensions of the piece, and then to realize at least one measurement of the actual dimensions of the blank mounted on the first spindle and then to modify the machining parameters of the control means for the no-force precision machining means in order to control, starting from the blank mounted on the first spindle, a second machining phase to remove a sufficiently small quantity of material in order to obtain the finished piece mounted on the first spindle, having a roughness Ra of less than 40 nm, preferably less than or equal to 12 nm and, more preferably, strictly less than 10 nm and, preferably, less than or equal to 9 nm and, more preferably, between 5 nm and 9 nm, limits included, and having the predetermined final dimensions, the machining parameters for the second phase possibly being corrected in accordance with the comparison of the actual measured dimensions of the blank mounted on the first spindle with the predetermined final dimensions.

The present invention also relates to a method for machining a piece, in particular a micromechanical piece, having at least one surface of revolution with axis of rotation A using the machine tool as defined above, said method comprising the following steps:
a) recording predetermined final dimensions of the piece to be achieved following machining with a predefined tolerance;
b) providing a piece to be machined;
c) mounting the piece to be machined in one of the spindles of the machine tool using its clamping device;
d) machining the piece to be machined, mounted on its spindle in rotation by the no-force precision machining means according to the first machining phase in order to obtain a blank mounted on its spindle, of which the target dimensions are 0.5% to 20% greater than the predetermined final dimensions of the piece;
e) measuring the dimensions of the piece machined according to the first machining phase of the preceding step using the optical measurement system for the first spindle in order to obtain actual measured dimensions of the blank mounted on its spindle;
f) comparing the actual dimensions measured in step e) with the predetermined final dimensions recorded in step a);
g) modifying the machining parameters of the control means for the no-force precision machining means in order to control, starting from the blank mounted on its spindle (12), the second machining phase;
h) if the actual dimensions measured in step e) differ from the target dimensions of the blank, correcting the machining parameters managed by the guidance system (20) for the second machining phase in accordance with the comparison of the measurements obtained in step f);
i) machining the blank mounted on its spindle in rotation by the no-force precision machining means in accordance with the machining parameters modified in step g), and possibly corrected in step h), according to the second machining phase to remove a sufficiently small quantity of material in order to obtain the finished piece mounted on the first spindle having a roughness Ra of less than 40 nm, preferably less than or equal to 12 nm and, more preferably, strictly less than 10 nm and, preferably, less than or equal to 9 nm and, more preferably, between 5 nm and 9 nm, limits included, and having the predetermined final dimensions.

The method according to the invention applies to each piece to be machined such that each machined piece is then measured and checked in situ on its spindle.

Such a machine and such a machining method make it possible to obtain machined pieces having extreme qualities of concentricity, coaxiality, precision, roughness and tolerance.

### BRIEF DESCRIPTION OF THE DRAWINGS

Other characteristics and advantages of the present invention will appear on reading the following detailed description of an embodiment of the invention, provided by way of non-limiting example and with reference to the appended drawings, wherein:

FIG. 1 shows a schematic view of a machine tool according to the invention;

FIG. 2 shows a schematic view of a spindle, of the clamping device and of an optical measurement system;

FIG. 3 shows a schematic view of a spindle and of a device for correcting the concentricity;

FIG. 4 shows an enlarged view of a piece mounted on its clamping device;

FIG. 5 shows a detailed view of FIG. 3 showing the spindle, the clamping device and the device for correcting the concentricity;

FIG. 6 shows a detailed view of the clamping device mounted on the spindle and of the device for correcting the concentricity;

FIG. 7 shows a sectional view of the clamping device mounted on the spindle and of the device for correcting the concentricity;

FIG. 8 shows a schematic representation of the steps of the method according to the invention; and

FIG. 9 shows a schematic representation of the steps of correcting the concentricity.

### EMBODIMENTS OF THE INVENTION

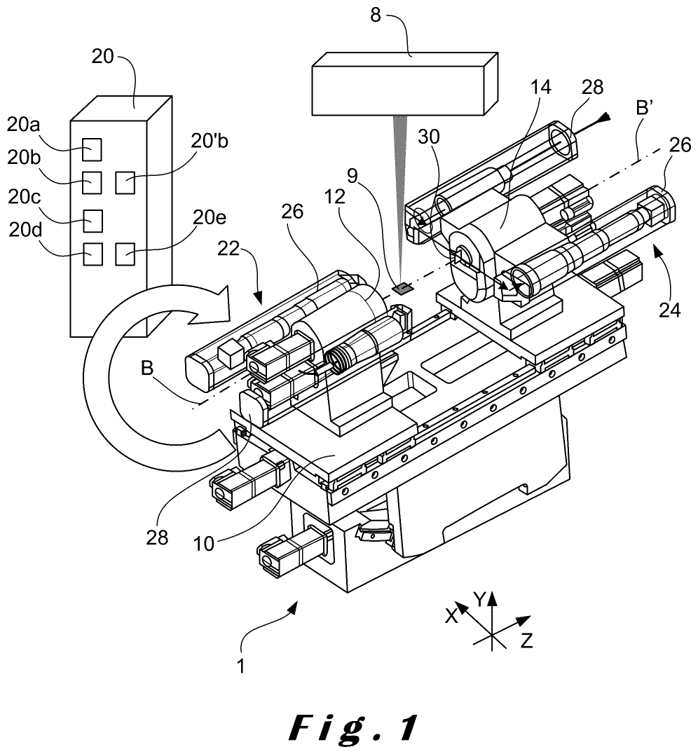

With reference to FIG. 1, the present invention relates to a machine tool 1 for machining a piece 2, in particular a micromechanical piece, having at least one surface of revolution with axis of rotation A. Such a piece is represented, for example, in FIG. 9. This piece 2 can be, for example, a precision pivot axis which can be of very small dimensions like a watchmaking pivot axis. Such a piece involves very small diameters, between 40 μm and 400 μm.

Such precision axes can be made of hard materials such as metallic materials of the hardened steel, stainless steel or Inconel type, or metallic glass, ceramics or silicon carbide-based materials.

The watchmaking pivot axis comprises at each of its ends a pivot 4, in the extension of a pivot-shank 6. Conventionally, at least said pivots have a surface of revolution, and are each intended to pivot in a bearing, typically in an orifice of a stone or ruby.

The watchmaking pivot axis traditionally has a diameter less than or equal to 2 mm and the pivot 4 has an outside diameter less than or equal to 200 μm, preferably less than or equal to 100 μm, preferably less than or equal to 90 μm and, more preferably, less than or equal to 60 μm when the pivot axis 2 is in the finished state, ready to be used. The pivot 4 is of the conical type, for example.

The watchmaking pivot axis can have a plurality of sections of different diameters, conventionally defining steps and shoulders, produced by machining.

The pivot axis can be a balance axis, for example. Of course, other types of watchmaking pivot axes can be envisaged such as, for example, axes of timepiece wheels and pinions, typically escapement pinions, barrel arbors or even anchor stems. In this case, the pivot axis can include functional elements linked to its use. For example, the axis can include toothing, threading or a hook for fixing the spring in the case of a barrel arbor. The pieces of this type have, at the level of the body, diameters of preferably less than 2 mm, and pivots having a diameter which is preferably less than 0.2 mm as described above, with a precision of a few microns. The piece described here is a pivot axis configured to preferably suit watchmaking applications, but it is obvious that it can be used in any other application requiring the same pivot axis configuration.

The piece 2 to be machined, mounted on the machine tool 1, can be a piece of material which can be machined effortlessly, a rough piece or a workpiece which will be entirely machined and finished in the machine tool 1 in order to obtain the piece having its final dimensions and roughness using one and the same machine tool 1.

The piece 2 to be machined, mounted on the machine tool 1, can also be a blank, that is to say a piece already partially machined using another method and another machine, for example involving removing chips, via a traditional profile-turning or conventional machining method or any other method for removing material, and which will be corrected and finished on the machine tool 1 in order to obtain the piece having its final dimensions and roughness.

The machine tool 1 comprises no-force precision machining means 8 arranged to machine the piece 2. In the present description, no-force or effortless machining is the name given to unconventional machining according to which there is no mechanical action transmitted by direct contact and effort between a tool and the piece, unlike conventional machining where there is direct contact between the tool and the piece and in which significant cutting forces are involved. No-force machining is therefore machining without direct contact between the piece to be machined and a machining tool which would be likely to exert an effort or a stress on said piece.

Advantageously, the no-force precision machining means 8 are arranged to strike the material radially and/or tangentially and/or axially to the piece 2 to be machined, and preferably radially, when the latter is in rotation.

Advantageously, the no-force precision machining means comprise means for machining by femto laser turning, by electrochemical turning (electrochemical machining (ECM)), or by electrical discharge turning (for example, EDM (electrical discharge machining)).

The no-force precision machining means are, preferably, a femto laser which delivers high-energy pulses over extremely short periods (of the order of 10-15 seconds). This makes possible material ablation processes without damage to the machining interface. Virtually any material can be machined by this process.

Advantageously, the femtosecond pulsed laser is a laser with wavelengths of, for example, between 200 nm and 2000 nm, preferably between 400 nm and 1000 nm, limits included. The characteristics of the laser can be, for example: average power between 1 W and 100 W, energy per pulse between 20 μJ and 4000 μJ, frequency between 100 KHz and 1000 kHz, pulse length between 100 fs and 2 ps.

The laser can be guided using a 2D scanning head (2 axes) or a precession head with at least 3 axes and, preferably, 5 axes. Such devices are available on the market.

The laser is guided and programmed to create an action zone 9, in the travel of the piece 2 to be machined, mounted on the machine 1. As will be described in more detail below, said action zone 9 is modified between a first machining phase and a second machining phase and evolves during the second machining phase in order to gradually reduce the interaction with the material, in order to obtain pieces with extreme precision and an extremely low roughness.

The machine tool also comprises a digital lathe 10 comprising at least one first spindle 12 and a second spindle 14 acting as a counter-spindle.

The first spindle 12 has an axis of rotation B extending along the Z axis into an XYZ coordinate system, said first spindle being movable in translation along the Z axis and in rotation around its axis of rotation B.

Similarly, the second spindle 14 has an axis of rotation B′ extending along the Z axis into the XYZ coordinate system, opposite the first spindle 12, said second spindle 14 being movable in translation along the Z axis and in rotation around its axis of rotation B′.

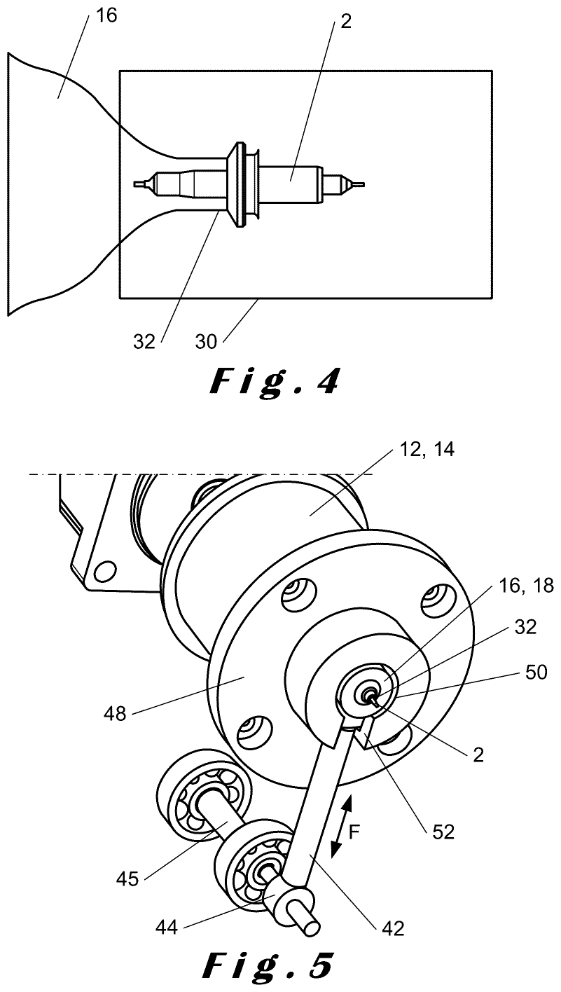

Each spindle 12, 14 is driven in rotation, supplied by a motor 15 (cf. FIG. 3).

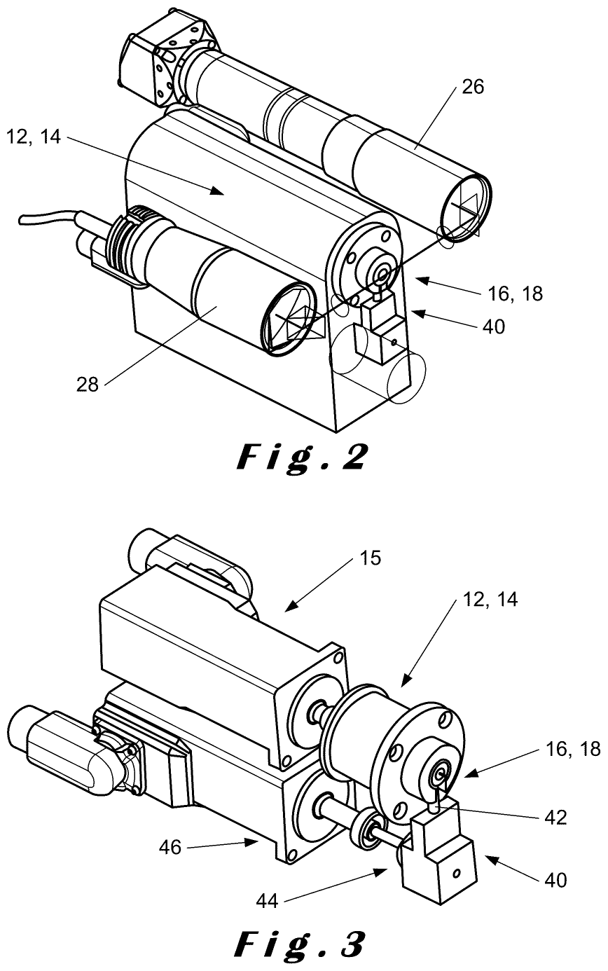

As shown, for example, in FIGS. 2 and 4, the first spindle 12 is associated with a first clamping device 16 arranged to clamp a first end of the piece 2 to be machined, and to leave the second end free by exposing the part to be machined of the piece 2, and to mount said piece 2 on said first spindle 12.

Similarly, the second spindle 14 is associated with a second clamping device 18 arranged to clamp the second end of the piece to be machined, and to leave the first end free by exposing the other part to be machined of the piece 2, and to mount said piece 2 on said second spindle 14.

The clamping devices 16, 18 will be subsequently described in detail.

The machine also comprises a guidance system 20 arranged to manage machining parameters which, in particular, comprise the operating characteristics of the no-force precision machining means 8 such as, for example, in the case of a femto laser, the power, the energy per pulse, the frequency, the pulse length, the different pass depths, the movement (circular, oscillatory, etc.) of the laser added to its primary movement with respect to the piece 2 in order to position the laser beam according to the machining phases, as will be described below, possibly the angles of attack (e.g., precession movements, tilting movements of the piece), etc.

For the electrochemical turning (ECM), the machining parameters are, for example, the voltage, current and electrolyte concentration. For the electrical discharge turning, the machining parameters are, for example, the voltage and current.

The machining parameters also comprise the rotational speed of the spindles 12, 14 (which can be constant or dynamically adjusted, for example synchronized with the speed of the laser beam), and the angle of inclination of the spindles with respect to the machining “plane” or with respect to the two other planes of Cartesian space.

The guidance system 20 is also arranged to manage the positioning of the no-force precision machining means 8 with respect to the piece 2 to be machined and the positioning of the clamping device 16, 18 with respect to its spindle 12 or, respectively 14, as will be described in more detail below.

The machine 1 can also comprise a device for supplying the pieces, a loading and unloading robot arranged to take a piece from the feed device, to position the piece in one of the clamping devices on a spindle, and then withdraw it following machining of the exposed part, to position the piece in the other clamping device on the other spindle, and then withdraw the machined piece and unload it.

The machine can also comprise an air conditioning system such that the entire environment of the machine is under thermal control, a water-cooling device for the laser, as well as all the connectors and power supplies necessary for its operation.

The machine tool 1 comprises a first optical measurement system 22 for the piece 2 arranged to at least measure the actual dimensions of the piece 2 when it is mounted on the first spindle 12 using the first clamping device 16. In a particularly advantageous manner, the first optical measurement system 22 is integrated into the first spindle 12, that is to say carried by the latter.

Similarly, in particular when the second spindle 14 is used to carry out machining, the machine can advantageously comprise a second optical measurement system 24 for the piece 2 arranged to at least measure the actual dimensions of the piece 2 when it is mounted on the second spindle 14 using the second clamping device 18. In a particularly advantageous manner, the second optical measurement system 24 is integrated into the second spindle 14, that is to say carried by the latter.

Thus, each system 22, 24 for measuring, by optical means, the actual dimensions of the piece mounted on its spindle is integrated into its respective spindle, making it possible to carry out measurements in situ, without having to withdraw the piece from its spindle and from its clamping device.

Advantageously, each optical measurement system 22, 24 comprises telecentric optics 26 associated with telecentric lighting 28, making possible collimated lighting, as represented in FIG. 2. Each optical measurement system 22, 24 is arranged to create a measurement field 30 around the piece 2 mounted on its clamping device 16, 18, as shown in FIGS. 1 and 4.

Furthermore, the guidance system 20 comprises:
recording means 20a for predetermined final dimensions of the piece to be achieved following machining with a predefined tolerance, the predetermined final dimensions to be achieved following machining being the final dimensions of the piece when the piece to be machined is a workpiece which is entirely machined and finished or a blank which is finished in the machine 1 in order to obtain said piece;
control means 20b for the first optical measurement system 22 in order to measure and record actual dimensions of the piece mounted on the first spindle 12;
control means 20′b for the second optical measurement system 24, when it is present, in order to measure and record the actual dimensions of the piece mounted on the second spindle 14;
comparison means 20c for comparing the actual measured dimensions of the piece with at least the predetermined final dimensions;
correction means 20d for adapting the machining parameters such as the characteristics of the laser or the rotational speed of the spindles 12, 14, in accordance with the comparison of the actual measured dimensions of the piece with at least the predetermined final dimensions;
control means 20e for the no-force precision machining means 8 in order to machine the piece in accordance with the machining parameters.

In accordance with the present invention, the guidance system 20 is arranged to guide said control means 20b for the first optical measurement system 22, said comparison means 20c, said control means 20e for the machining means 8, and possibly said correction means 20d, in order to control a first machining phase of the exposed part of the piece 2 mounted on the first spindle 12 in its clamping device 16, said first phase being programmed to obtain a blank mounted on the first spindle 12 in its clamping device 16, and of which the target dimensions, in particular the target diameter, have been chosen to be 0.5% to 20% greater than the predetermined final dimensions of the piece 2, in particular the final predetermined diameter of the piece 2, and then to realize at least one measurement of the actual dimensions of the blank mounted on the first spindle 12 in its clamping device 16 and then to modify the machining parameters of the control means for the no-force precision machining means in order to control, starting from the blank mounted on the first spindle 12 in its clamping device 16, a second machining phase to remove a sufficiently small quantity of material in order to obtain the finished piece 2 mounted on the first spindle 12 in its clamping device 16, said piece 2 having a roughness Ra, uniform to ±20%, of less than 40 nm, preferably less than or equal to 25 nm, preferably less than or equal to 20 nm, preferably less than or equal to 15 nm and, preferably, less than or equal to 12 nm and, more preferably, strictly less than 10 nm and, preferably, less than or equal to 9 nm and, more preferably, between 5 nm and 9 nm, limits included, and having the predetermined final dimensions, the machining parameters for the second phase possibly being corrected with respect to the machining parameters corresponding to a blank having the target dimensions, in accordance with the comparison of the actual measured dimensions of the blank mounted on the first spindle 12 in its clamping device 16 with the target dimensions of the blank, which are defined with respect to said predetermined final dimensions. The possible correction of the machining parameters is therefore realized in accordance with the comparison of the actual measured dimensions of the blank with the predetermined final dimensions.

The roughness Ra is defined according to the ISO 4287 standard.

Similarly, the guidance system 20 is arranged to guide said control means 20′b for the second optical measurement system 24, when it is present, said comparison means 20c, said control means 20e for the machining means 8, and possibly said correction means 20d, in order to control a third machining phase of the other exposed part of the piece 2 mounted on the second spindle 14 in its clamping device 18 that is programmed to obtain a blank mounted on the second spindle 14 in its clamping device 18, and of which the target dimensions have been chosen to be 0.5% to 20% greater than the predetermined final dimensions of the piece 2, and then to realize at least one measurement of the actual dimensions of the blank mounted on the second spindle 14 in its clamping device 18 and then to modify the machining parameters of the control means for the no-force precision machining means in order to control, starting from the blank mounted on the second spindle 14 in its clamping device 18, a fourth machining phase to remove a sufficiently small quantity of material in order to obtain the finished piece 2 mounted on the second spindle 14 on its clamping device 18, said piece having a roughness Ra, uniform to ±20%, of less than 40 nm, preferably less than or equal to 25 nm, preferably less than or equal to 20 nm, preferably less than or equal to 15 nm and, preferably, less than or equal to 12 nm and, more preferably, strictly less than 10 nm and, preferably, less than or equal to 9 nm and, more preferably, between 5 nm and 9 nm, limits included, and having the predetermined final dimensions, the machining parameters for the fourth phase possibly being corrected in accordance with the comparison of the actual measured dimensions of the blank mounted on the second spindle 14 in its clamping device 18 with the target dimensions of the blank, which are defined with respect to said predetermined final dimensions and, therefore, with the predetermined final dimensions.

Advantageously, the guidance system is arranged to guide said control means 20e for the no-force precision machining means 8 and their machining parameters such that the energy applied to the piece 2 during the second machining phase is at least 40% less than the energy applied to the piece 2 during the first machining phase, the energy applied to the piece 2 during the second machining phase preferably being able to decrease as the interactions with the material progress in order to have a very fine removal of material on each interaction with the material of the piece and to have a better machining resolution during the second phase.

For example, for the electrochemical turning (ECM), the adjustable machining parameters are, in particular, the voltage, current and electrolyte concentration. For the electrical discharge turning, the adjustable machining parameters are, in particular, the voltage and current.

Advantageously, the no-force precision machining means 8 are means for machining by femto laser turning. The no-force precision machining means are, preferably, arranged to emit a beam, the diameter of which is less than 20 μm, preferably less than 8 μm. The diameter of a laser beam defines its transversal extension, that is to say its physical size perpendicularly to the direction of propagation. It is defined at width 1/e² which is delimited by the points where the intensity of the beam reaches 1/e² (≈13.5%) of its maximum value.

The guidance system is arranged to guide said control means 20e for the no-force precision machining means 8 to control the positioning of the beam in order to interact with the material of the piece 2 such that more than 50% of the diameter of the beam is used during the first machining phase and such that less than 50% of the diameter of the beam is used during the second machining phase.

For example, for no-force precision machining by femto laser, a spot having a diameter of less than or equal to 8 μm, preferably less than or equal to 6 μm or, indeed, 4 μm is preferably used, the laser beam striking the pivot axis in rotation radially.

Thus, the guidance system 20 of the invention is arranged to machine a piece which remains on its spindle in its clamping device during the two machining phases while being able to be measured. The piece obtained is machined with extreme precision of the order of less than or equal to ±1 μm, preferably less than or equal to ±0.5 μm, and an extreme roughness as defined above.

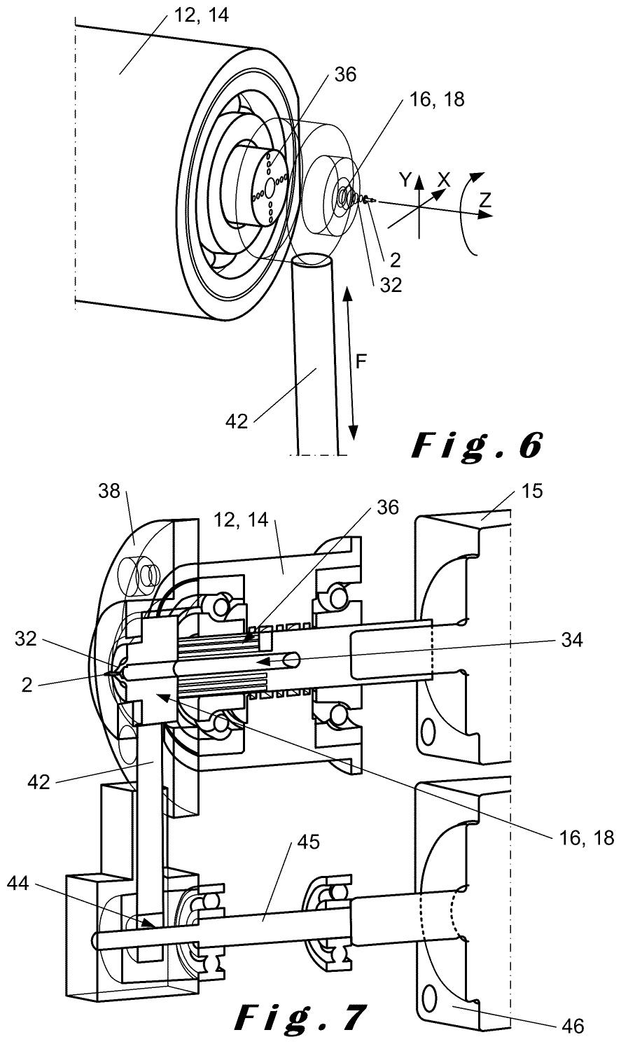

The clamping devices 16, 18 and their mounting on their respective spindle 12, 14, will now be described in detail with reference to FIGS. 3 to 7.

In a particularly advantageous manner, each clamping device 16, 18 comprises a system for clamping or holding the piece 2 to be machined by vacuum, such as an integrated Venturi system which is arranged to create a depression and to hold the piece 2 flattened into its clamping device 16, 18.

More particularly and with reference to FIG. 7, each clamping device 16, 18 comprises a clamping head 32 having an orifice into which one end of the piece 2 to be machined is introduced, said orifice communicating with the Venturi system via a channel 34.

Furthermore, there is also provided a vacuum holding system 36 for the clamping device 16, 18 on its respective spindle 12, 14, which is linked to the integrated Venturi system, the depression created also making it possible to hold each clamping device 16, 18, flattened onto its respective spindle 12, 14, in a fixed position at least during the machining operations.

In a particularly advantageous manner, as the no-force precision machining implemented according to the invention, in particular by femto laser, is carried out without a mechanical effort, it is then possible to use a vacuum clamping system to hold the piece in its clamping device and a vacuum holding system to hold the clamping device on its spindle.

Advantageously, the guidance system 20 is arranged to check the vacuum in order to be able to move the clamping device in the XY plane at least along the Y axis when this is necessary to correct the concentricity, as will be described below. Thus, each clamping device 16, 18 is arranged to be held on its respective spindle 12, 14 along the Z axis and to be able to be moved in the XY plane at least along the Y axis by a control from the guidance system 20 in order to correct the concentricity.

To this end, each optical measurement system 22, 24 of the piece 2 is arranged to also measure the concentricity of said piece 2 to be machined, mounted on its spindle 12, 14, between the axis of rotation A of the piece 2 and the axis of rotation B, B′ of the spindle 12 or, respectively 14.

Furthermore, the machine tool 1 comprises a device for correcting the concentricity 40 associated with each clamping device 16, 18, said correction device 40 being arranged to be able to move the clamping device 16, 18 in translation in the XY plane along the Y axis.

More particularly and with reference to FIGS. 5 to 7, the device for correcting the concentricity 40 comprises a rod 42 arranged to be able to cooperate radially along the Y axis with the outer periphery of the clamping device 16, 18 by pressing on said periphery, and a correction cam 44 comprising an eccentric cooperating with said rod 42 by pressing on said rod 42, and arranged to be driven in rotation by being integral with a shaft 45 driven by a motor 46.

The flange 48 of the spindle 12, 14 has a housing 50 in which the clamping device 16, 18 is positioned with a certain play at least in Y to be able to position and recenter, if necessary, said clamping device 16, 18 with respect to the axis of its spindle 12, 14. In addition, the housing 50 has a radial opening 52, making it possible for the rod 42 to pass through to be able to come into contact radially with said clamping device 16, 18 when it is actuated by the correction cam 44.

The correction cam 44 is arranged to be controlled by the guidance system 20 in order to move the rod 42 in translation along the Y axis, as represented by arrow F, in order to move the clamping device 16, 18 in translation along the Y axis in accordance with the concentricity to be corrected.

Furthermore, the guidance system 20 is arranged to control an angular movement of the spindle 12, 14 in the XY plane in accordance with the concentricity to be corrected.

More particularly, the guidance system 20 is arranged to control an angular movement of the spindle 12, 14 in the XY plane and/or to control a movement of the clamping device 16, 18 in translation in the XY plane along the Y axis via the correction device 40 such that the axes of rotation A, B or, respectively B′ of the piece 2 to be machined and of its spindle 12 or, respectively 14 coincide prior to machining.

Thus, the radial position of each clamping device 16, 18 clamping the piece 2 is corrected with respect to the axis of rotation B, B′ of the associated spindle 12, 14 prior to machining, making it possible to obtain a machined piece having extreme qualities of concentricity and of coaxiality.

Advantageously, each optical measurement system 22, 24 for the piece 2 is arranged to measure the actual roughness of the piece to be machined, the guidance system 20 being arranged to compare said actual roughness with a predetermined final roughness to be achieved.

The invention also relates to the method for machining a piece 2, in particular a micromechanical piece, having at least one surface of revolution with axis of rotation A using a machine tool 1 as described above.

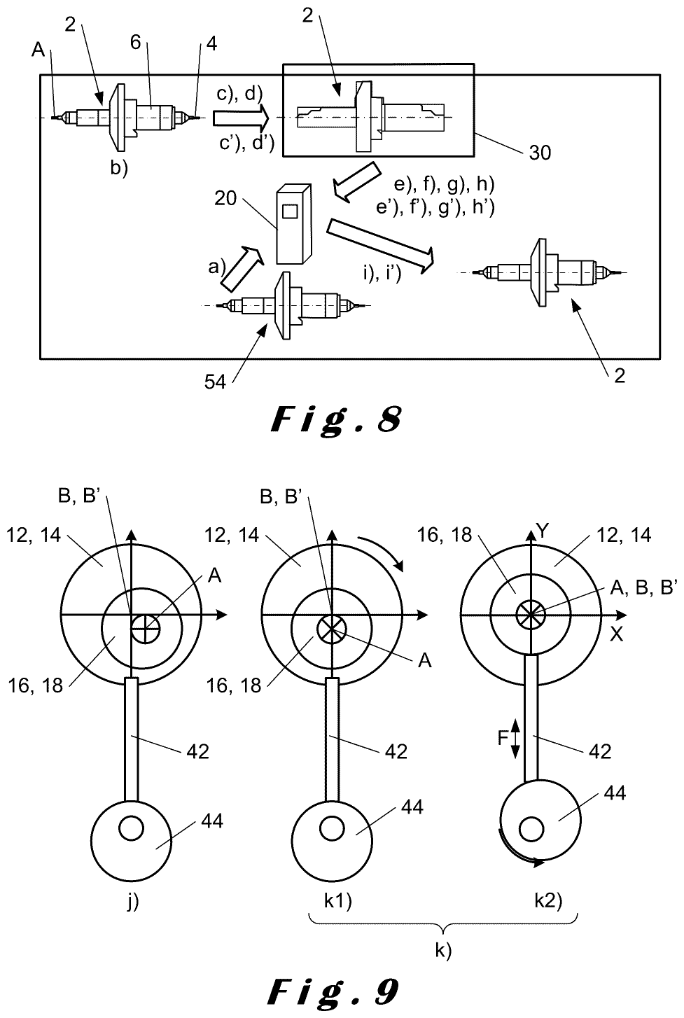

The method according to the invention advantageously includes the following steps, with reference to FIG. 8:
a) recording, with the recording means 20a of the guidance system 20, predetermined final dimensions of the piece 2 to be achieved following machining with a predefined tolerance, corresponding to a model piece 54, said predetermined final dimensions to be achieved following machining being the final dimensions of the piece when the piece to be machined is a workpiece which is entirely machined and finished or a blank which is finished in the machine 1 in order to obtain said piece;
b) providing a piece 2 to be machined;
c) mounting the piece 2 to be machined in one of the spindles 12, 14 of the machine tool 1 using its associated clamping device 16, held by vacuum, said clamping device 16 having previously been positioned in a centered manner on its spindle 12, and the positioning of the spindle 12 and the initial positioning of the no-force precision machining means 8, in particular a femtosecond laser, in order to correctly position its action zone 9, having previously been adjusted using a test piece;
d) machining by the no-force precision machining means 8, in particular a femtosecond laser, the exposed part of the piece 2 to be machined by striking the material radially and/or tangentially and/or axially, preferably radially, to the piece 2 mounted on its spindle 12 in rotation via its clamping device 16, according to the first machining phase that is programmed to obtain a blank mounted on its spindle 12, of which the target dimensions are 0.5% to 20% greater than the predetermined final dimensions of the model piece 54;
e) measuring and recording the dimensions of the piece 2 machined according to the first machining phase of the preceding step in the measurement field 30 using the associated optical measurement system 22 provided on the first spindle 12 of the machine tool 1 and control means 20b for the guidance system 20 in order to obtain the actual measured dimensions of the blank of the piece 2 mounted on its associated spindle 12;
f) comparing the actual dimensions measured in step e) with the predetermined final dimensions of the model piece 54 recorded in step a), and therefore compared with respect to the target dimensions of the blank, which are defined with respect to said final dimensions, using the comparison means 20c of the guidance system 20;
g) modifying the machining parameters of the control means for the no-force precision machining means in order to control, starting from the blank mounted on its spindle 12, the second machining phase, the machining parameters modified for the second machining phase being more particularly, in the case of a femto laser, the characteristics of the laser, namely the power, its distance with respect to the piece, the energy per pulse, the frequency, the pulse length, and/or the rotational speed of the associated spindle 12; for the electrochemical turning (ECM), the machining parameters are, for example, the voltage, current and electrolyte concentration; for the electrical discharge turning, the machining parameters are, for example, the voltage and current;
h) if the actual dimensions measured in step e) differ from the target dimensions of the blank, correcting the machining parameters managed by the guidance system 20 for the second machining phase in accordance with the comparison of the measurements obtained in step f) using the correction means 20d; in the case of a femto laser, the corrected machining parameters are, more particularly, the characteristics of the laser, namely the power, its distance with respect to the piece, the energy per pulse, the frequency, the pulse length, and/or the rotational speed of the associated spindle 12; for the electrochemical turning (ECM), the machining parameters are, for example, the voltage, current and electrolyte concentration; for the electrical discharge turning, the machining parameters are, for example, the voltage and current;
i) machining the exposed part of the blank of the piece 2 by striking the material radially and/or tangentially and/or axially, preferably radially, to the piece 2 mounted on its spindle in rotation 12 by the no-force precision machining means 8, controlled by the control means 20e of the guidance system 20, in accordance with the machining parameters modified in step g), and possibly corrected in step h), according to the second machining phase to remove a sufficiently small quantity of material in order to obtain the finished piece 2 mounted on the first spindle 12, having a roughness Ra, uniform to ±20%, of less than 40 nm, preferably less than or equal to 25 nm, preferably less than or equal to 20 nm, preferably less than or equal to 15 nm and, preferably, less than or equal to 12 nm and, more preferably, strictly less than 10 nm and, preferably, less than or equal to 9 nm and, more preferably, between 5 nm and 9 nm, limits included, and having the predetermined final dimensions.

Then, in the event that the aim is to machine the other part of the piece 2 following machining of the exposed part of the piece 2 mounted on the spindle 12, the machining method according to the invention advantageously comprises the following steps:
c′) withdrawing, by the robot, the machined piece 2 from its clamping device 16 held on the spindle 12 and mounting it in the other spindle 14 of the machine tool 1 using its associated clamping device 18, held by vacuum, said clamping device 18 having previously been positioned in a centered manner on its spindle 14, and the positioning of the spindle 14 and the initial positioning of the no-force precision machining means 8, in particular a femtosecond laser, in order to correctly position its action zone 9, having previously been adjusted using a test piece;
d′) machining by the no-force precision machining means 8, in particular a femtosecond laser, the exposed part of the piece 2 to be machined by striking the material radially and/or tangentially and/or axially, preferably radially, to the piece 2 mounted on its spindle 14 in rotation via its clamping device 18, according to the third machining phase that is programmed to obtain a blank mounted on its spindle 14, of which the target dimensions are 0.5% to 20% greater than the predetermined final dimensions of the model piece 54;
e′) measuring and recording the dimensions of the piece 2 machined according to the third machining phase of the preceding step in the associated measurement field 30 using the associated optical measurement system 24 provided on the second spindle 14 of the machine tool 1 and control means 20′b of the guidance system 20 in order to obtain the actual measured dimensions of the blank of the piece 2 mounted on its associated spindle 14;
f′) comparing the actual dimensions measured in step e′) with the predetermined final dimensions of the model piece 54 recorded in step a), and therefore compared with respect to the target dimensions of the blank, which are defined with respect to said final dimensions, using the comparison means 20c of the guidance system 20;
g′) modifying the machining parameters of the control means for the no-force precision machining means in order to control, starting from the blank mounted on its spindle 14, the fourth machining phase; the machining parameters modified for the fourth machining phase being more particularly, in the case of a femto laser, the characteristics of the laser, namely the power, its distance with respect to the piece, the energy per pulse, the frequency, the pulse length, and/or the rotational speed of the associated spindle 12; for the electrochemical turning (ECM), the machining parameters are, for example, the voltage, current and electrolyte concentration; for the electrical discharge turning, the machining parameters are, for example, the voltage and current;
h′) if the actual dimensions measured in step e′) differ from the target dimensions of the blank, correcting the machining parameters managed by the guidance system 20 for the fourth machining phase in accordance with the comparison of the measurements obtained in step f′) using the correction means 20d; in the case of a femto laser, the corrected machining parameters are, more particularly, the characteristics of the laser, namely the power, its distance with respect to the piece, the energy per pulse, the frequency, the pulse length, and/or the rotational speed of the associated spindle 14; for the electrochemical turning (ECM), the machining parameters are, for example, the voltage, current and electrolyte concentration; for the electrical discharge turning, the machining parameters are, for example, the voltage and current;
i′) machining the exposed part of the blank of the piece 2, by striking the material radially and/or tangentially and/or axially, preferably radially, to the piece 2 mounted on its spindle in rotation 14 by the no-force precision machining means 8, controlled by the control means 20e of the guidance system 20, in accordance with the machining parameters modified in step g′), and possibly corrected in step h′), according to the fourth machining phase to remove a sufficiently small quantity of material in order to obtain the finished piece (2) mounted on the second spindle (14), having a roughness Ra, uniform to ±20%, of less than 40 nm, preferably less than or equal to 25 nm, preferably less than or equal to 20 nm, preferably less than or equal to 15 nm and, preferably, less than or equal to 12 nm and, more preferably, strictly less than 10 nm and, preferably, less than or equal to 9 nm and, more preferably, between 5 nm and 9 nm, limits included, and having the predetermined final dimensions.

These steps of the method for machining the piece 2 on the second spindle 14 are optional and can be implemented or not according to the configurations of the piece 2.

Advantageously, the machining method according to the invention comprises, prior to machining according to step d) and/or d′), the following intermediate steps, with reference to FIG. 9:
j) measuring the concentricity of the piece 2 to be machined, mounted on its spindle 12, 14 between the axis of rotation A and the axis of rotation of the spindle B or, respectively B′ by the optical measurement system 22, 24 associated with its spindle 12 or, respectively 14;
k) correcting the concentricity of the piece 2 to be machined with respect to the axis of rotation B or, respectively B′ of its associated spindle 12 or, respectively 14, by moving its clamping device 16 or, respectively 18, using the associated device for correcting the concentricity 40 such that the axes of rotation A, B or, respectively B′, of the piece 2 to be machined and of its associated spindle 12 or, respectively 14, coincide.

More particularly, step k) comprises a first sub-step k1) of angularly correcting the spindle 12, 14 in the XY plane by angular movement of the spindle 12, 14 and therefore of the associated clamping device 16, 18, the rotation of the spindle 12, 14 being controlled by the guidance system 20 in accordance with the concentricity to be corrected.

Step k) comprises a second sub-step k2) of radially correcting the clamping device 16, 18 by moving it in translation in the XY plane along the Y axis, as shown by arrow F, using the rod 42 which has come into radial support, pushed by the correction cam 44 driven in rotation and controlled by the guidance system 20 in accordance with the concentricity to be corrected. During this sub-step k2, the guidance system 20 is arranged to check the vacuum in order to be able to move the clamping device 16, 18 in the XY plane at least along the Y axis in order to recenter it with respect to the axis of its associated spindle 12, 14.

It is necessary to correct the concentricity, for example, when the clamping device is off-center with respect to its spindle when the piece to be machined is placed in its clamping device. Depending on the position of the clamping device, only step k2) may be necessary. If the axes of the spindle and of the piece to be machined are coaxial from the outset, only step j) involving measuring the concentricity is implemented, step k) not being necessary.

The different steps b) to i), c′) to i′), j) and k) described above apply to each piece 2 to be machined. All of the pieces 2 are then measured and checked.

Advantageously, the control means 20e for the no-force precision machining means 8 and their machining parameters are managed by the guidance system that is programmed such that the energy applied to the piece 2 during the second machining phase is at least 40% less than the energy applied to the piece 2 during the first machining phase, the energy applied to the piece 2 during the second machining phase preferably being able to decrease as the interactions with the material progress in order to have a very fine removal of material on each interaction with the material of the piece and to have better machining resolution during the second phase.

For example, for the electrochemical turning (ECM), the adjustable machining parameters are, in particular, the voltage, current and electrolyte concentration. For the electrical discharge turning, the adjustable machining parameters are, in particular, the voltage and current.

During the first phase, the no-force machining means, managed by the guidance system 20 that is programmed to this end, work on the basis of the same machining parameters, the removal of material being constant on each interaction with the piece, until such time as the oversize corresponding to the target dimensions of the blank chosen to be 0.5% to 20% greater than the final dimensions of the piece 2 is achieved. The no-force machining means like the laser take, as references, a fixed point outside the piece and the known position of the axis of rotation of the piece, which is constant given that any concentricity has been corrected at the outset, prior to the machining according to steps j) and k).

In the case of the femto laser, it is chosen to emit a beam, the diameter of which is less than 20 μm. The guidance system of said control means 20e for the no-force precision machining means 8 is programmed to control the positioning of the beam in order to interact with the material of the piece 2 such that more than 50% of the diameter of the beam is used during the first machining phase and such that less than 50% of the diameter of the beam is used during the second machining phase.

More specifically, during the first machining phase, the beam is moved parallel to the axis of rotation of the piece, while approaching the axis of rotation of the piece, more than 50% of the diameter of the beam being used to interact with the material of the piece 2 in order to have a significant amount of energy available, making it possible to remove a significant quantity of material. The energy applied to the piece is substantially constant during the first machining phase in order to remove the same quantity of material on each interaction with the piece. The laser stops when it reaches the oversize, the value of the oversize, between 0.5% and 20% of the final dimensions of the piece 2, being chosen in accordance with the dimension of the beam, the time authorized to conduct the second phase, and the roughness Ra sought.

Between the first and the second phases, the machining parameters such as the power parameters are modified by the guidance system that is programmed to this end, the femto laser being moved so as to place its focal point such that less than 50% of the diameter of the beam is used to interact with the material of the piece 2. Once the laser has been positioned by its control means 20b guided by the guidance system 20, it remains at a constant distance from the axis of rotation of the piece, while the beam continues to be moved parallel to the axis of rotation, by going back and forth. For this reason, the beam touches less and less material, with very little energy, such that that very little material is removed each time, and less and less material is removed with each interaction of the beam with the piece. Thus, the quality factor of the beam evolves, which makes it possible to machine such small pieces with such high precision and such low roughness Ra. The progressive reduction of the interaction zone during the second machining phase makes it possible to finely check the machining energy and to obtain extreme roughness values Ra.

For example, in order to machine a piece having a diameter of 100 μm with a femto laser having a spot diameter of 8 μm, an oversize of 2 μm is chosen, to with the target dimensions of the blank achieved at the end of the first machining phase being 2% greater than the final diameter. For the second machining phase, the femto laser is positioned with respect to the blank by the guidance system 20 such that ⅛ of the laser beam is used. A finished piece having the diameter sought with a roughness Ra of 9 nm is obtained. If an oversize of 1 μm is chosen, to with the target dimensions of the blank achieved at the end of the first machining phase being 1% greater than the final diameter, the femto laser is positioned for the second machining phase such that 1/16 of the laser beam is used. A finished piece having the diameter sought with a roughness Ra of less than 9 nm is obtained.

If the measurement of the blank taken by the optical measurement system 22, 24 between the first and second machining phases does not conform to the target dimensions, that is to say the chosen oversize, following the comparison with the comparison means 20c, the machining parameters for the second phase are corrected by the correction means 20d in order to position the femto laser with respect to the blank, taking into account the actual value of the oversize.

The machine tool 1 and the machining method implemented by said machine tool 1 according to the invention make it possible to realize a machining according to two machining phases with dimensional measurements in situ of the pieces by optical systems incorporated in the spindles between the two phases, the machining parameters being modified between the two phases, and possibly corrected in accordance with the results of the dimensional measurements of the pieces, without dismantling the piece from its spindle, making it possible to obtain machined pieces within extreme precisions, less than or equal to ±1 μm, preferably less than or equal to ±0.5 μm, and extremely low roughness values Ra.

Furthermore, the machine tool 1 and the machining method implemented by said machine tool 1 according to the invention make it possible, prior to machining, to measure, by optical systems, the concentricity of rotation of the piece to be machined in its spindle and to correct the radial position of the clamping device of the piece with respect to the axis of rotation of its spindle in accordance with the measurement of concentricity realized. The correction of the concentricity and the machining of the pieces are carried out in the same location in the same clamp, which makes it possible to obtain machined pieces having extreme qualities of concentricity and of coaxiality.

It is obvious that the device for correcting the concentricity 40 and the elements necessary for its operation can be used in a machine tool in order to recenter the clamping device of a piece with respect to its spindle.

1. A machine tool for machining a piece having at least one surface of revolution with axis of rotation A, said machine tool comprising no-force precision machining means arranged to machine the piece, a lathe comprising at least one first spindle having an axis of rotation B extending along the Z axis into an XYZ coordinate system, said first spindle being movable in translation along the Z axis and in rotation around the first spindle's axis of rotation B, a first clamping device arranged to clamp the piece to be machined and to mount it the piece on the first spindle, a first optical measurement system for the piece integrated into the first spindle and arranged to at least measure the actual dimensions of the piece when the piece is mounted on the first spindle using the first clamping device, and a guidance system arranged to manage machining parameters, the guidance system comprising:
recording means for predetermined final dimensions of the piece to be achieved following machining with a predefined tolerance,
control means for the first optical measurement system in order to measure and record actual dimensions of the piece mounted on the first spindle,
comparison means for comparing the actual measured dimensions of the piece with at least the predetermined final dimensions,
correction means for adapting the machining parameters in accordance with the comparison of the actual measured dimensions of the piece with at least the predetermined final dimensions,
control means for the no-force precision machining means in order to machine the piece in accordance with the machining parameters,
wherein said guidance system is arranged to guide said control means for the first optical measurement system, said comparison means, said control means for the no-force precision machining means, and possibly, said correction means, in order to control a first machining phase of the piece mounted on the first spindle that is programmed to obtain a blank mounted on the first spindle, of which the target dimensions are 0.5% to 20% greater than the predetermined final dimensions of the piece, and then to realize at least one measurement of the actual dimensions of the blank mounted on the first spindle and then to modify the machining parameters of the control means for the no-force precision machining means in order to control, starting from the blank mounted on the first spindle, a second machining phase to remove a sufficiently small quantity of material in order to obtain the finished piece mounted on the first spindle, having a roughness Ra of less than 40 nm, and having the predetermined final dimensions, the machining parameters for the second phase possibly being corrected in accordance with the comparison of the actual measured dimensions of the blank mounted on the first spindle with the predetermined final dimensions.

2. The machine tool according to claim 1, wherein the lathe comprises a second spindle having an axis of rotation B′ extending along the Z axis opposite the first spindle, said second spindle being movable in translation along the Z axis and in rotation around said second spindle's axis of rotation B′, wherein the machine tool comprises a second clamping device arranged to clamp the piece to be machined and to mount the piece on the second spindle and a second optical measurement system for the piece integrated into the second spindle arranged to at least measure the actual dimensions of the piece when it is mounted on the second spindle using the second clamping device, the guidance system comprising control means for the second optical measurement system in order to measure and record the actual dimensions of the piece mounted on the second spindle and being arranged to guide said control means for the second optical measurement system, said comparison means, said control means for the no-force precision machining means, and possibly said correction means, in order to control a third machining phase of the piece mounted on the second spindle that is programmed to obtain a blank mounted on the second spindle, of which the target dimensions are 0.5% to 20% greater than the predetermined final dimensions of the piece, and then to realize at least one measurement of the actual dimensions of the blank mounted on the second spindle and then to modify the machining parameters of the control means for the no-force precision machining means in order to control, starting from the blank mounted on the second spindle, a fourth machining phase to remove a sufficiently small quantity of material in order to obtain the finished piece mounted on the second spindle, having a roughness Ra of less than 40 nm, and having the predetermined final dimensions, the machining parameters for the fourth phase possibly being corrected in accordance with the comparison of the actual measured dimensions of the blank mounted on the second spindle with the predetermined final dimensions.

3. The machine tool according to claim 1, wherein the no-force precision machining means are arranged to strike the material of the piece to be machined radially and/or tangentially and/or axially to said piece.

4. The machine tool according to claim 1, wherein the no-force precision machining means comprise means for machining by femto laser turning, by electrochemical turning, or electrical discharge turning.

5. The machine tool according to claim 1, wherein the guidance system is arranged to guide said control means for the no-force precision machining means and their machining parameters such that the energy applied to the piece during the second machining phase is at least 40% less than the energy applied to the piece during the first machining phase, the energy applied to the piece during the second machining phase being able to decrease as the interactions with the material progress.

6. The machine tool according to claim 4, wherein the no-force precision machining means are means for machining by femto laser turning arranged to emit a beam, the diameter of which is less than 20 μm, and wherein the guidance system is arranged to guide said control means for the no-force precision machining means to control the positioning of the beam in order to interact with the material of the piece such that more than 50% of the diameter of the beam is used during the first machining phase and such that less than 50% of the diameter of the beam is used during the second machining phase.

7. The machine tool according to claim 1, wherein the optical measurement system comprises telecentric optics associated with telecentric lighting.

8. The machine tool according to claim 1, wherein the clamping device comprises a vacuum clamping system for the piece to be machined.

9. The machine tool according to claim 1, further comprising a vacuum holding system for the clamping device on its respective spindle.

10. The machine tool according to claim 1, wherein the clamping device is arranged to be held on the clamping device's respective spindle along the Z axis and to be able to be moved in a XY plane at least along the Y axis by a control from the guidance system.

11. The machine tool according to claim 10, wherein the optical measurement system for the piece is arranged to measure the concentricity of the piece to be machined, mounted on its spindle between the axis of rotation A and the axis of rotation B, respectively B′ of the spindle, wherein the machine tool comprises a device for correcting the concentricity associated with a clamping device, said correction device being arranged to be able to move its clamping device in translation in the XY plane along the Y axis, and wherein the guidance system is arranged to control an angular movement of the spindle in the XY plane and/or to control a movement of the clamping device in translation along the Y axis via its correction device such that the axes of rotation of the piece to be machined and of its spindle coincide prior to machining.

12. The machine tool according to claim 11, wherein the device for correcting the concentricity comprises a rod arranged to be able to cooperate with the associated clamping device and a correction cam cooperating with said rod and arranged to be driven in rotation and controlled by the guidance system in order to move said rod along the Y axis in order to move the clamping device in translation along the Y axis in accordance with the concentricity to be corrected.

13. The machine tool according to claim 1, wherein the optical measurement system for the piece is arranged to measure the actual roughness of the piece to be machined, and wherein the guidance system is arranged to compare said actual roughness with a predetermined roughness to be achieved, and to modify the machining parameters in accordance with the comparison of the actual roughness of the piece with the predetermined roughness.

14. The machine tool according to claim 1, wherein the machining parameters comprise the operating characteristics of the no-force precision machining means, the rotational speed of the spindles and the inclination of the spindles.

15. A method for machining a piece having at least one surface of revolution with axis of rotation A using a machine tool according to claim 1, wherein said method comprises the following steps:
a) recording predetermined final dimensions of the piece to be achieved following machining with a predefined tolerance;
b) providing a piece to be machined;
c) mounting the piece to be machined in one of the spindles of the machine tool using its clamping device;
d) machining the piece mounted on its spindle in rotation by the no-force precision machining means according to the first machining phase in order to obtain a blank mounted on its spindle, of which the target dimensions are 0.5% to 20% greater than the predetermined final dimensions of the piece;
e) measuring the dimensions of the piece machined according to the first machining phase of the preceding step using the optical measurement system for the first spindle in order to obtain actual measured dimensions of the blank mounted on its spindle;
f) comparing the actual dimensions measured in step e) with the predetermined final dimensions recorded in step a);
g) modifying the machining parameters of the control means for the no-force precision machining means in order to control, starting from the blank mounted on its spindle, the second machining phase;
h) if the actual dimensions measured in step e) differ from the target dimensions of the blank, correcting the machining parameters managed by the guidance system for the second machining phase in accordance with the comparison of the measurements obtained in step f);
i) machining the blank mounted on its spindle in rotation by the no-force precision machining means in accordance with the machining parameters modified in step g), and possibly corrected in step h), according to the second machining phase, to remove a sufficiently small quantity of material in order to obtain the finished piece mounted on the first spindle, having a roughness Ra of less than 40 nm, and having the predetermined final dimensions.

16. The machining method according to claim 15, wherein said method comprises, following machining of the piece on one of the spindles, the following steps:
c′) withdrawing the machined piece from one of the spindles and mounting the machined piece in the other spindle of the machine tool using the other spindle's clamping device;
d′) machining the piece mounted on its spindle in rotation by the no-force precision machining means according to the third machining phase in order to obtain a blank mounted on its spindle, of which the target dimensions are 0.5% to 20% greater than the predetermined final dimensions of the piece;
e′) measuring the dimensions of the piece machined according to the third machining phase of the preceding step using the optical measurement system for the second spindle in order to obtain actual measured dimensions of the blank mounted on its spindle;
f) comparing the actual dimensions measured in step e′) with the predetermined final dimensions recorded in step a);
g′) modifying the machining parameters of the control means for the no-force precision machining means in order to control, starting from the blank mounted on its spindle, the fourth machining phase;
h′) if the actual dimensions measured in step e′) differ from the target dimensions of the blank, correcting the machining parameters managed by the guidance system for the fourth machining phase in accordance with the comparison of the measurements obtained in step f′);
i′) machining the blank mounted on its spindle in rotation by the no-force precision machining means in accordance with the machining parameters modified in step g′), and possibly corrected in step h′), according to the fourth machining phase to remove a sufficiently small quantity of material in order to obtain the finished piece mounted on the second spindle, having a roughness Ra of less than 40 nm, and having the predetermined final dimensions.

17. The machining method according to claim 15, further comprising, prior to machining according to step d) or d′), the following intermediate steps:
j) measuring the concentricity of the piece to be machined, mounted on its spindle between the axis of rotation A and the axis of rotation of the spindle by the optical measurement system associated with its spindle;
k) correcting the concentricity of the piece to be machined with respect to the axis of rotation of its spindle by moving its clamping device such that the axes of rotation of the piece to be machined and of its spindle coincide.

18. The machining method according to claim 15, wherein the no-force precision machining means comprise means for machining by femto laser turning, by electrochemical turning, or electrical discharge turning.

19. The machining method according to claim 15, wherein the control means for the no-force precision machining means and their machining parameters are guided by the guidance system that is programmed such that the energy applied to the piece during the second machining phase is at least 40% less than the energy applied to the piece during the first machining phase, the energy applied to the piece during the second machining phase being able to decrease as the interactions with the material progress.

20. The machining method according to claim 18, wherein the no-force precision machining means are means for machining by femto laser turning arranged to emit a beam, the diameter of which is less than 20 μm, and wherein the guidance system of said control means for the no-force precision machining means is programmed to control the positioning of the beam in order to interact with the material of the piece such that more than 50% of the diameter of the beam is used during the first machining phase and such that less than 50% of the diameter of the beam is used during the second machining phase.

21. The machining method according to claim 15, wherein the machining parameters comprise the operating characteristics of the no-force precision machining means, the rotational speed of the spindles and the inclination of the spindles.
